(19) United States
(12) Patent Application Publication
(10) Pub. No.: US 2011/0056360 A1
(43) Pub. Date: Mar. 10, 2011

(54) Pick for playing a stringed instrument

(76) Inventor: Richard Ouellette, Moncton (CA)

(21) Appl. No.: 12/585,222

(22) Filed: Sep. 9, 2009

(51) Int. Cl. G10D 3/16; B29C 65/00

(52) U.S. Cl. 84/322; 264/241

(57) ABSTRACT

A pick for playing a stringed instrument comprises a main body having a first portion and a second portion. The first portion has a front surface and a back surface, and a peripheral edge adjoining the front surface and the back surface. The second portion has a front surface and a back surface, and a peripheral edge adjoining the front surface and the back surface. The first portion and the second portion are secured together one to the other at the back surface of each, thereby forming an interface between the first portion and the second portion. The front surface of each of the first portion and the second portion is outwardly facing.

### FIELD OF THE INVENTION

The present invention relates to picks for playing a stringed instrument, and more particularly to such picks made from an epoxy, polyurethane or other liquid resin mixtures and materials, which harden to predetermined customizable shapes.

### BACKGROUND OF THE INVENTION

Stringed musical instruments are instruments in which sound is produced by the vibrations of one or more taut strings that are strung over most of the length of the musical instrument. The vibrations are produced either by drawing a bow across the strings, or in the case of some types of non-bowed stringed musical instruments, such as the guitar, banjo, ukulele, harp, dulcimer, and so on, are produced by either ones fingertips, or preferably by a pick, plectrum, or the like, held by ones fingers and thumb. The pick is drawn across one or more of the strings of the musical instrument at a time, in a plucking or strumming manner to play music.

Typically, conventional picks for stringed musical instruments are made from resilient plastic material with a smooth surface. Although these conventional picks have been around for a number of years, and are generally thought to work quite well, there are a number of drawbacks with these conventional picks for stringed musical instruments, and specifically for the guitar, which is the most commonly played of these types of stringed musical instruments. Accordingly, for the sake of ease of reference, guitar picks will be generally focused on in this background.

The most significant drawback is that such picks do not conform to the finger position of the guitarist. Accordingly, known prior art guitar picks are not as comfortable as they might otherwise be.

Further, not all shapes are possible with present conventional picks. Most guitar picks are generally triangularly shaped, with a few other shapes possible, that can be readily formed by using standard guitar pick manufacturing techniques. These picks require expensive dies or molds to attain the desired size and shape of guitar pick, which is often cost prohibitive to small production runs of custom shape guitar picks.

Additionally, it is difficult to print full color photographic quality pictures on conventional plastic picks. Most conventional picks are made from colorful plastic material, and are of one or more colors. Often, such guitar picks have a single color design printed thereon. It is not known in the prior art to produce guitar picks having full color photographic quality pictures on them.

Further, it is difficult to produce a completely transparent pick by utilizing the standard guitar pick manufacturing products presently available, either as an entire pick, or with photograph, or similar, within the guitar pick such that the photograph is readily viewable. Having a viewable photograph, or similar, within the guitar pick, is highly desirable as it would allow for the production guitar picks having pictures of favorite musicians or groups, or alternatively other subject matter such as logos of sports teams or pictures of professional athletes, and so on.

One such prior art pick that overcomes these problems is disclosed, by the present inventor in Canadian patent application 2,585,512 and U.S. patent application Ser. No. 11/788,846. While it has been found that this pick does solve the problems of other prior art picks and does work extremely well, improvements can still be made, in terms of improved sounding tone of a stringed instrument being played, less pick noise, longer pick durability, and the protection of graphic images.

One other prior art guitar pick is taught in U.S. Pat. No. 7,179,976 issued Feb. 20, 2007 to West, which discloses a Fingernail Pick for Stringed Instruments that is removably attachable to a user's fingernail. In that patent, at column 7, in the paragraph beginning at line 39, it is stated with reference to FIG. 11, that “ . . . the replaceable playing surface 11 allows for the interchange of different types of playing surfaces. For example, playing surfaces made from different materials could be used to change the volume, tone or timbre of the instrument. Examples of different materials that could be used as the playing surface 11 include, but are not limited to, various plastics, thermoplastics, glass, graphite, ceramics, fiberglass, resin, animal products, plant material, metal, wood or stone.” In that patent, it is referred to only obliquely that resins could be used to form a fingernail pick. It does not specifically teach that guitar picks can be made from epoxy resin.

There are also two other prior art documents that are only somewhat related.

United States Published Patent Application No. 2004/0031372 published Feb. 19, 2004 to Glyde discloses a Floating Blade Plectrum wherein the blade 1 has a cloth attachment 2 secured to the blade 1 using epoxy resin.

U.S. Pat. No. 4,248,128 issued Feb. 3, 1981 to Des Gaines discloses a Guitar Pick Array having a base 13 that is made from epoxy. The actual guitar picks are not made from epoxy resin.

It is an object of the present invention to provide a pick for playing a stringed instrument, which pick provides better sounding tone from a stringed musical instrument being played.

It is another object of the present invention to provide a pick for playing stringed instrument, which pick provides less pick noise.

It is another object of the present invention to provide a pick for playing a stringed instrument, which pick has longer durability than prior art picks.

It is a further object of the present invention to provide a pick for playing a stringed instrument, which pick for playing a stringed instrument, has a protected internal graphic image.

### SUMMARY OF THE INVENTION

In accordance with one aspect of the present invention there is disclosed a novel pick for playing a stringed instrument. The pick comprises a main body having a first portion and a second portion. The first portion has a front surface and a back surface, and a peripheral edge adjoining the front surface and the back surface. The second portion has a front surface and a back surface, and a peripheral edge adjoining the front surface and the back surface. The first portion and the second portion are secured together one to the other at the back surface of each, thereby forming an interface between the first portion and the second portion, wherein the front surface of each of the first portion and the second portion is outwardly facing.

In accordance with another aspect of the present invention there is disclosed a novel pick for playing a stringed instrument. The pick comprises a main body having a first portion and a second portion. The first portion has a front surface and a back surface, and a peripheral edge adjoining the front surface and the back surface. The second portion has a front surface and a back surface, and a peripheral edge adjoining the front surface and the back surface. A graphic image is disposed between the first portion and the second portion.

In accordance with another aspect of the present invention there is disclosed a novel method of forming a pick for playing a stringed instrument. The method comprises the steps of introducing liquid resin onto a receiving surface to thereby form a first portion; allowing the first portion to at least partially cure; and introducing liquid resin onto the first portion to thereby form a second portion on the first portion, thereby forming a main body of the pick.

In accordance with another aspect of the present invention there is disclosed a novel method of forming a pick for playing a stringed instrument. The method comprising the steps of forming a first portion; forming a second portion; and securing the second portion to the first portion.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the pick according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of the first preferred embodiment of the pick according to the present invention;

FIG. 2 is a top plan view of the first preferred embodiment pick of FIG. 1;

FIG. 3 is a side elevational view of the first preferred embodiment pick of FIG. 1;

FIG. 4 is a bottom plan view of the first preferred embodiment pick of FIG. 1;

FIG. 5 is a top plan view of the method of forming a pick for playing a stringed instrument, according to the present invention, showing the graphic images and the shape and size of a pick, formed on a thin flat backing;

FIG. 6 is a top plan view of one piece of the thin flat backing of FIG. 5, cut out to the shape and size of a pick;

FIG. 7 is a perspective view of a plurality of the thin flat backings of FIG. 6, placed in a curing tray;

FIG. 8 is a perspective view of one of the plurality of the thin flat backings of FIG. 6, and showing a resin mixture being introduced onto the front surface of the thin flat backing, to form a similar shape first portion of the pick;

FIG. 9 is a side elevational view of the first portion of the pick of FIG. 8, with the thin flat backing being removed;

FIG. 10 is a side elevational view of the first portion of the pick of FIG. 9, having been flipped over such that the front surface is facing downwardly; and,

FIG. 11 is a side elevational view similar to FIG. 10, but additionally showing a resin mixture being introduced onto the back surface of the first portion of the pick, to form a similar shape second portion of the pick.

### DETAILED DESCRIPTION OF THE PREFERRED EMBODIMENT

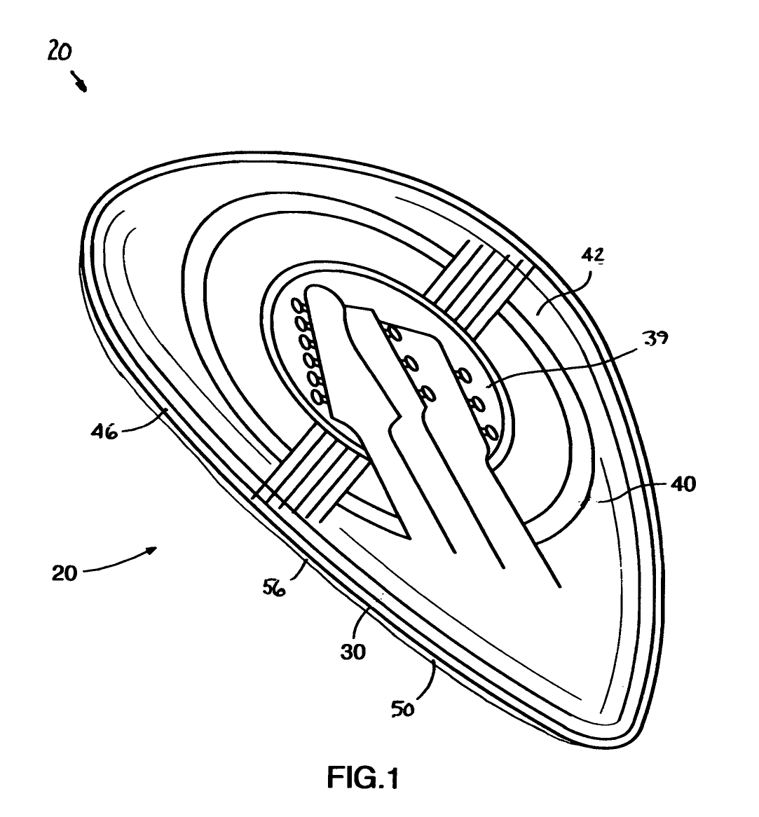

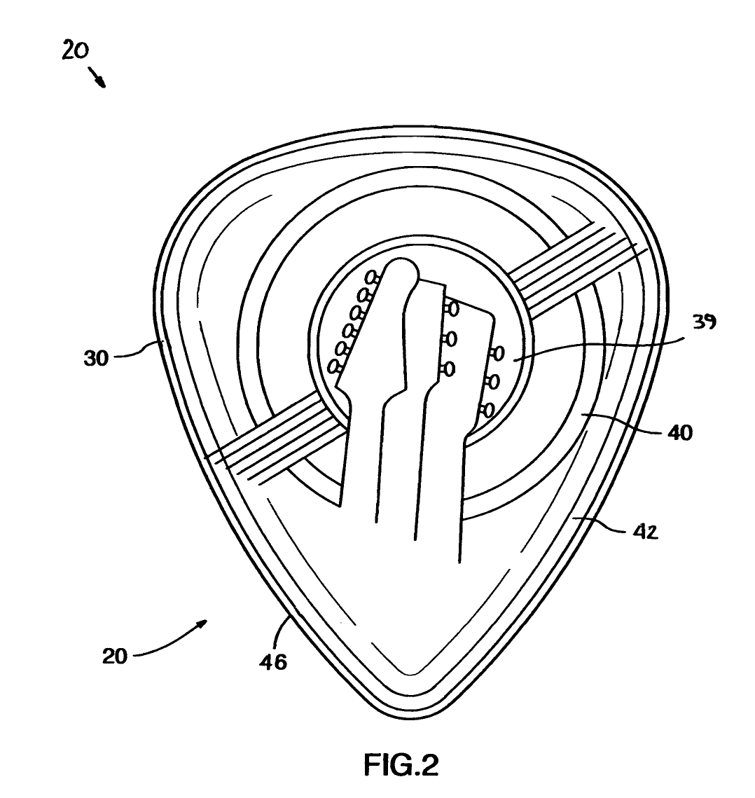

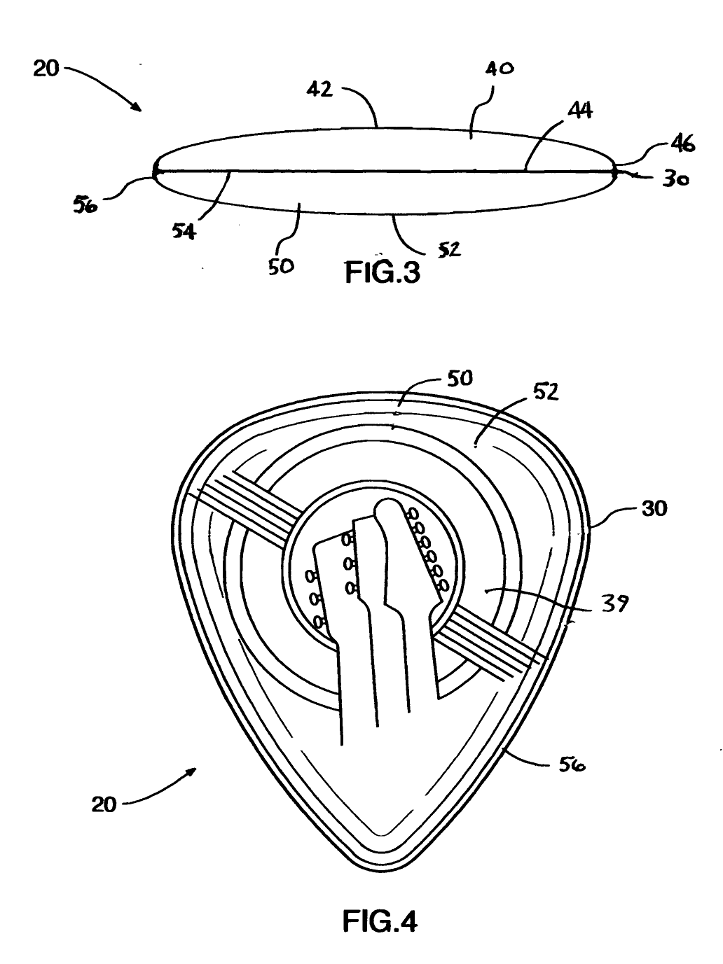

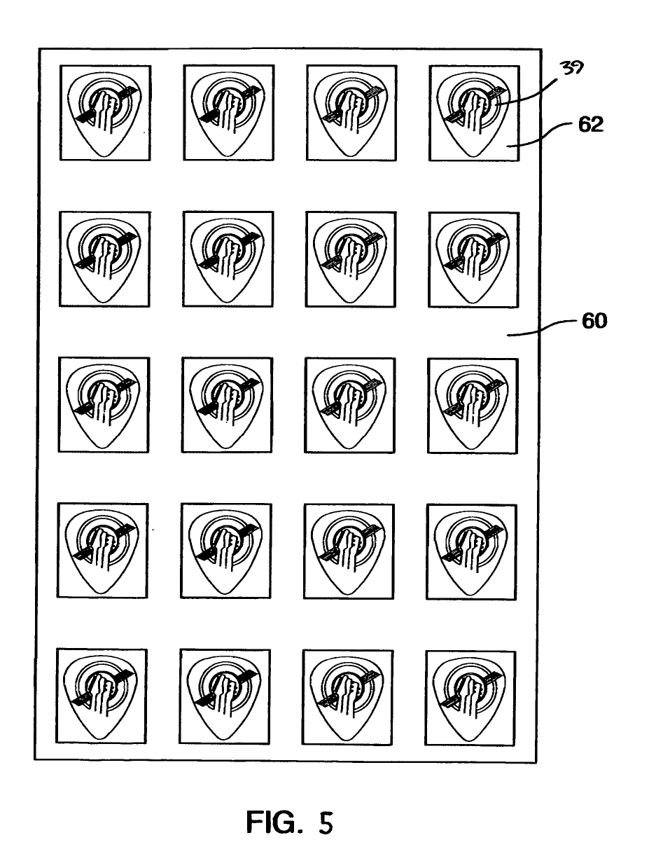

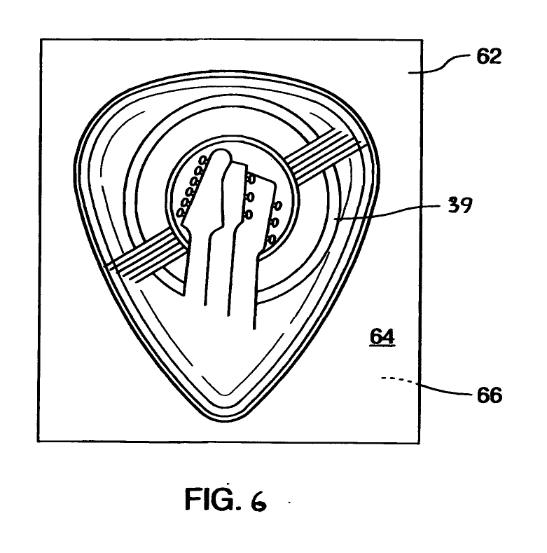

Referring to FIGS. 1 through 11 of the drawings, it will be noted that FIGS. 1 through 4 illustrate a preferred embodiment of the pick according to the present invention, and FIGS. 5 through 11 illustrate a method of forming a pick according to the present invention.

Reference will now be made to FIGS. 1 through 4, which show a preferred embodiment of the pick of the present invention, as indicated by general reference numeral 20. The pick 20 is for playing a stringed instrument, such as a guitar. The first preferred embodiment pick 20 comprises a main body 30 having a first portion 40 and a second portion 50. The first portion 40 has a front surface 42 and a back surface 44, and a peripheral edge 46 adjoining the front surface 42 and the back surface 44. Similarly, the second portion 50 has a front surface 52 and a back surface 54, and a peripheral edge 56 adjoining the front surface 52 and the back surface 54.

In the preferred embodiment, both the peripheral edge 46 and the peripheral edge 56 are substantially aligned one with the other, and can be any suitable shape for a pick 20.

The first portion 40 and the second portion 50 are secured together one to the other at the respective back surfaces 44,54 of each thereby forming an interface between the first portion 40 and the second portion 50. Accordingly, the front surface 42,52 of the first portion 40 and the second portion 50, respectively, are each outwardly facing.

At least a substantial portion of the main body 30, and preferably each of the first portion 40 and the second portion 50, comprises a doming mixture, which is preferably a resin mixture. Preferably at least a substantial portion of the main body 30 comprises epoxy resin. The preferred embodiment pick 20 according to the present invention is made from an epoxy, polyurethane or other liquid resin mixtures and materials which harden to predetermined customizable shapes.

As can be readily seen in the figures, especially in FIG. 3, the front surface 42 of the first portion 40 and the front surface 52 of the second portion 50 are substantially dome shaped. This dome shape results from the manufacturing operation, as will discussed subsequently. Further, the back surface 44 of the first portion 40 and the back surface 54 of the second portion 50 are substantially flat. The pick 20 is domed on both the front surface 42 of the first portion 40 and the back surface 54 of the second portion 50. In the preferred embodiment, as illustrated, the first portion 40 and the second portion 50 are substantially the same volume one as the other. Alternatively, the first portion of the main body and the second portion of the main body may be somewhat different in volume one from the other.

As can readily be seen in FIGS. 1, 2 and 4, the back surface 44 of the first portion 40 carries a graphic image 39. The graphic image 39 is therefore disposed between the first portion 40 and the second portion 50. This graphic might be of a musical artist or band, or may be of a professional team, or might even be a company logo, or even any picture, as desired.

Preferably, the graphic image 39 is made from a releasing ink. Alternatively, the graphic image 39 can be made from a small sheet of plastic film, or thin plastic, or the like. It is further contemplated that the sheet of plastic film could extend across the entire back surface 44 of the first portion 40 and the entire back surface 54 of the second portion 50, without the first portion 40 and the second portion 50 actually touching each other.

In the first preferred embodiment, as illustrated, both the first portion 40 and the second portion 50 of the main body 30 of the pick 20 comprise a resin mixture, preferably epoxy resin. The epoxy resin is substantially clear, or in other words transparent, such that the graphic image 39 may be viewed through both the first portion 40 and the second portion 50.

Reference will now be made to FIGS. 5 to 11, which show a preferred method of forming a pick 20 for playing a stringed instrument, such as a guitar. The preferred method comprising the following steps that will now be described in detail.

First, the first portion 40 is formed by introducing a doming mixture, such as a liquid resin, onto a receiving surface such as a thin flat backing 62. For the formation of the first portion 40, the thin flat backing 62 is provided. As illustrated in FIG. 5, each thin flat backing 62 is cut from a sheet of print media 60. Only one of the twenty thin flat backings shown in FIG. 5 is indicated by reference numeral 62 for ease of illustration. Preferably, the thin flat backing 62, shown separately in FIG. 6, has a front surface 64 and a back surface 66, and is made from a water resistant material, such as vinyl or waterproof paper. The thin flat backing 62 preferably has a special coating on it to absorb and retain ink that forms a graphic image 39 that will subsequently be printed onto the main body 30 of the pick 20. Accordingly, the step of providing a thin flat backing 62 for the pick 20 comprises printing the graphic image 39 onto print media 60.

The graphic image 39 on thin flat backing 62 might be related to music, such as a musical artist or band, or might be a professional team, a company logo, and so on, as desired.

Preferably, the graphic image 39 is made from a releasing ink, such that the graphic image 39 transfers to the bottom surface 44 of the front portion 40 of the hardened resin mixture pick 20.

Next, the thin flat backing 62 is cut into a pre-determined shape. More specifically, the print media 60 as shown in FIG. 5 is cut into a number of predetermined shapes, such as the shape shown in FIG. 6.

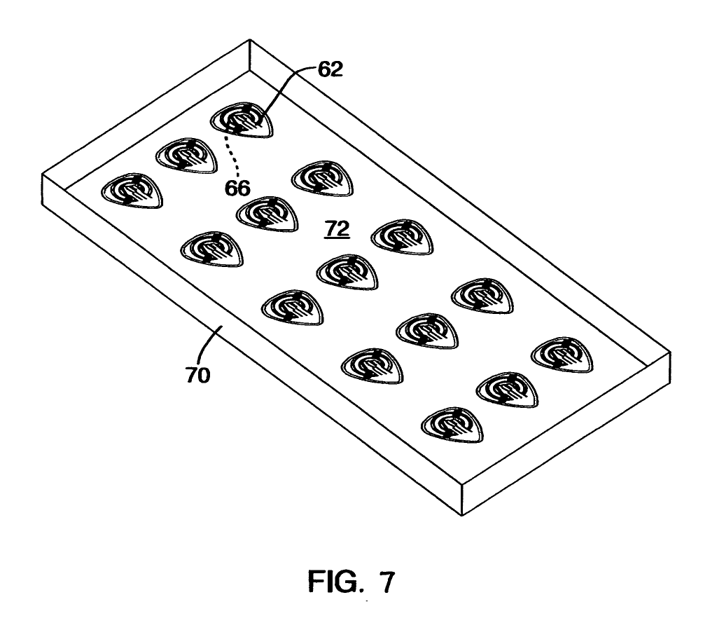

As can be seen in FIG. 7, the thin flat backings 62 are placed onto a curing tray 70 with the back surface 66 of each thin flat backing 62 against the curing tray 70 and the front surface 64 of each thin flat backing 62 facing generally upwardly. Preferably, the curing tray 70 comprises an adhesive curing tray 70, or in other words has a mildly adhesive upwardly facing receiving surface 72 that keeps the thin flat backings 62 in place absolutely flat on the curing tray 70.

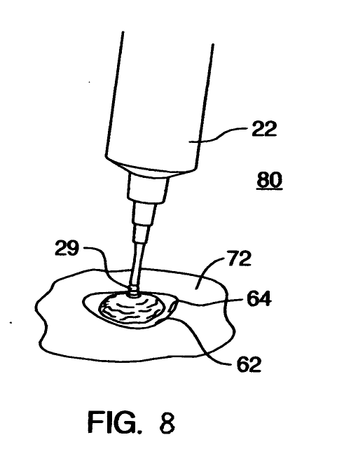

Next, as can be seen in FIG. 8, a doming mixture, which is preferable, a resin mixture, is carefully introduced onto the front surface 64 of the thin flat backing 62. The resin mixture, which is preferably a liquid epoxy resin, as indicated by the reference numeral 29, is reasonably viscous, and accordingly flows slowly to the outer edge of the thin flat backing 62. Surface tension causes of the liquid epoxy resin 29, which of course is the doming mixture, to stop at the outer edge of the thin flat backing 62, thus defining and forming the first portion 40 of the pick 20. Accordingly, the first portion 40 of the pick 20 will have the same shape as the thin flat backing 62. The doming material can also be polyurethane, or any other suitable material.

Preferably, but not necessarily, the step of introducing the doming mixture 29 onto the thin flat backing 62 is performed with a syringe device 22. Other suitable methods they also be used. Also, the step of introducing the doming mixture 29 onto the thin flat backing 62 is performed in an environmentally controlled area 80, in order to control temperature, dust and humidity.

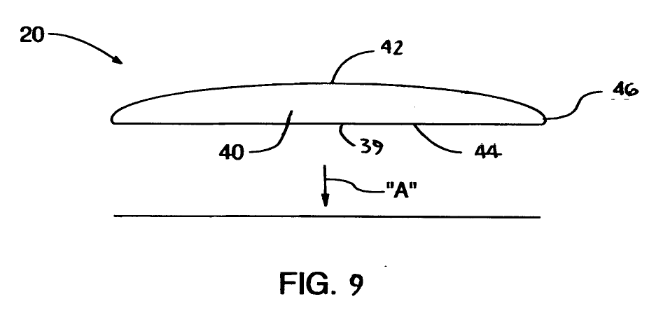

The resin mixture 29 that forms the first portion 40 is then permitted to at least partially cure and preferably fully cure, thus forming a hardened resin mixture first portion 40 with its front surface 42, back surface 44, and peripheral edge 46. Next, as shown in FIG. 9, the thin flat backing 62 is separated from the hardened resin mixture pick 20, as indicated by arrow “A”. The ink that forms the graphic image 39 on the thin flat backing 62 transfers to the back surface 44 of the first portion 40 of the pick 20 as a graphic image 39.

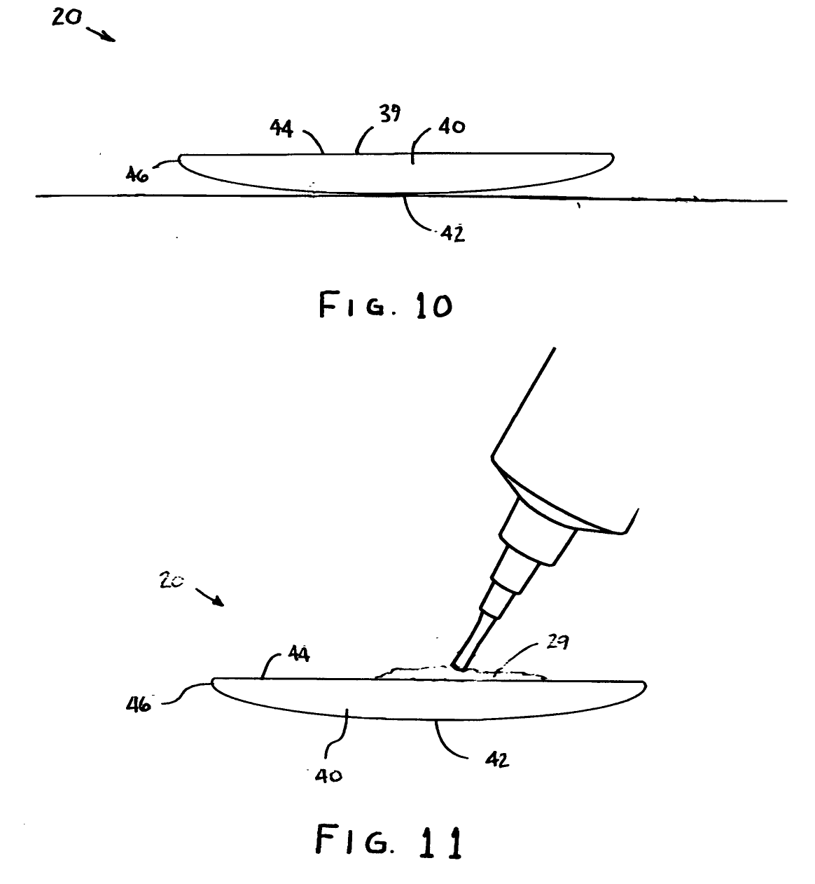

The next steps of the method according to the present invention are as follows. The hardened first portion 40 is turned over upside-down, or in other words flipped, such that, as can be seen in FIG. 10, the first portion 40 is oriented such that the back surface 44 of the first portion 40 is facing generally upwardly. It has been found that in spite of the domed front surface 42 of the first portion 40, the first portion 40 is usually stable enough when in the upside-down position with the back surface 44 facing upwardly. Alternatively, a curing tray with suitable depressions or cut-out portions, or the like, can be used to support the first portion 40 when in the upside-down position with the back surface 44 facing upwardly.

Next, as can be seen in FIG. 11, are the steps of forming a second portion 50; securing the second portion 50 to the first portion 40; and permitting the doming mixture to cure thus forming a main body 30 having a first portion 40 and a second portion 50. These steps are accomplished by introducing a doming mixture 29, such as a liquid resin, onto the back surface 44 of the first portion 40, to thereby form the second portion 50 of the main body 30 of the pick 20. The second portion 50 is formed on the first portion 40, thereby forming the main body 30 of the pick 20. In this manner, the second portion 50 is formed directly on the first portion 40, and is thereby secured to the first portion 40 as the doming resin 29 of the second portion 50 cures. The graphic image 39 remains in place on the front portion 40. The first portion 40 and the second portion 50 are not separable one from the other.

It should be noted that if the same amount of doming mixture is used for the front portion 40 and the second portion 50, the main body of the pick 20 will be symmetrical from front to back. Alternatively, the front portion and the back portion can be somewhat different sizes, but preferably are similar in size.

Utilizing this new manufacturing method, photo quality images may be introduced onto a pick 20 by using a specialized print media which allows the transfer of photo quality images onto the print media, and then subsequently completely releases and transfers the image on to the underside of the main body 30 of the pick 20, when the doming mixture is applied to this specialized media.

As can readily be seen, the graphic image 39 can be viewed the first portion 40 or the second portion 50, thus providing a highly aesthetic quality to the pick 20. Further, the graphic image 39 is protected from wearing or fading.

By using our new manufacturing technique with specialized print media and specialized cutting equipment, small custom shape runs can be prepared using a printer/media cutting device (not specifically shown) or plotter to determine the specific size and shape of the pick 20 without use of expensive dyes or production molds. The doming mixture is poured on to the precut media shape and hardens to the exact size and shape of the precut media.

As can be understood from the above description and from the accompanying drawings, the present invention provides a pick for playing a stringed instrument made from epoxy resin, which pick provides better sounding tone from a stringed musical instrument than do prior art picks, provides less pick noise than do prior art picks, has longer durability than do prior art picks, and has a protected internal graphic image, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the picks and of the present invention without departing from the spirit and scope of the accompanying claims.

I claim:

1. A pick for playing a stringed instrument, said pick comprising:
a main body having a first portion and a second portion;
wherein said first portion has a front surface and a back surface, and a peripheral edge adjoining said front surface and said back surface;
wherein said second portion has a front surface and a back surface, and a peripheral edge adjoining said front surface and said back surface; and,
a graphic image disposed between said first portion and said second portion.

2. The pick of claim 1, at least one of said first portion and said second portion is substantially clear.

3. The pick of claim 1, wherein said peripheral edge of said first portion and said peripheral edge of said second portion are substantially aligned one with the other.

4. The pick of claim 1, wherein at least a substantial portion of said first portion and said second portion of said main body each comprise a doming mixture.

5. The pick of claim 1, wherein the entire first portion and the entire second portion of said main body each comprise a doming mixture.

6. A pick for playing a stringed instrument, said pick comprising:
a main body having a first portion and a second portion;
wherein said first portion has a front surface and a back surface, and a peripheral edge adjoining said front surface and said back surface;
wherein said second portion has a front surface and a back surface, and a peripheral edge adjoining said front surface and said back surface; and,
wherein said first portion and said second portion are secured together one to the other at the back surface of each, thereby forming an interface between said first portion and said second portion, wherein said front surface of each of said first portion and said second portion is outwardly facing.

7. The pick of claim 6, at least one of said first portion and said second portion is substantially clear.

8. The pick of claim 6, further comprising a graphic image disposed between said first portion and said second portion.

9. The pick of claim 6, wherein said peripheral edge of said first portion and said peripheral edge of said second portion are substantially aligned one with the other.

10. The pick of claim 6, wherein at least a substantial portion of said first portion and said second portion of said main body each comprise a doming mixture.

11. The pick of claim 6, wherein the entire first portion and the entire second portion of said main body each comprise a doming mixture.

12. A method of forming a pick for playing a stringed instrument, said method comprising the steps of:
introducing liquid resin onto a receiving surface to thereby form a first portion;
allowing said first portion to at least partially cure; and,
introducing liquid resin onto said first portion to thereby form a second portion on said first portion, thereby forming a main body of said pick.

13. The method of claim 12, wherein the step of introducing liquid resin onto a receiving surface to thereby form a first portion comprises the steps of:
providing a thin flat backing having a front surface and a back surface;
placing the thin flat backing onto a curing tray with said back surface against the curing tray and said front surface facing generally upwardly; and,
introducing said liquid resin onto said front surface of said thin flat backing.

14. The method of claim 13, wherein prior to the step of introducing liquid resin onto said first portion, there is a step of:
separating said thin flat backing from said first portion.

15. The method of claim 13, wherein the step of forming a second portion comprises the steps of:
orienting said first portion with said back surface facing generally upwardly;
introducing said liquid resin onto said back surface of said first portion, to thereby form said second portion on said first portion; and,
permitting said liquid resin to cure, thus forming a main body having a first portion and a second portion with an interface between said first portion and said second portion.

16. The method of claim 12, wherein said liquid resin comprises a doming mixture.

17. The method of claim 12, further comprising the step of introducing a graphic image to the back surface of said first portion, prior to introducing liquid resin onto said first portion.

18. The method of claim 13, wherein the step of providing a thin flat backing for said pick comprises printing a graphic image onto said front surface of said thin flat backing.

19. The method of claim 13, further comprises the step of cutting the thin flat backing into a pre-determined shape.

20. A method of forming a pick for playing a stringed instrument, such as a guitar, said method comprising the steps of:
forming a first portion;
forming a second portion; and,
securing said second portion to said first portion.
